(19) United States
(12) Patent Application Publication
(10) Pub. No.: US 2016/0149992 A1
(43) Pub. Date: May 26, 2016

(54) ELECTRONIC DEVICE AND METHOD FOR DOWNLOADING FILE

(71) Applicant: Chiun Mai Communication Systems, Inc., New Taipei (TW)

(72) Inventors: WEI-RUNG CHEN, New Taipei (TW); CHIEN-FENG YEH, New Taipei (TW)

(21) Appl. No.: 14/876,201

(22) Filed: Oct. 6, 2015

(30) Foreign Application Priority Data
Nov. 26, 2014 (CN) 201410698767.6

(51) Int. Cl. H04L 29/08

(52) U.S. Cl. CPC H04L 67/06; H04L 67/327; H04L 67/02

(57) ABSTRACT

A method for downloading a file from a server device using a client device. The client device includes a plurality of electronic devices. The method includes sending a file downloading request to the server device from one of the electronic devices, and sending an assist request to each of the other electronic devices of the client device, thus, enabling each of the electronic devices to receive a segment of the file from the server device. A complete file can be generated according to the segments of the file from the server device received by the electronic devices.

### CROSS-REFERENCE TO RELATED APPLICATIONS

This application claims priority to Chinese Patent Application No. 201410698767.6 filed on Nov. 26, the contents of which are incorporated by reference herein.

### FIELD

The subject matter herein generally relates to data transmission, and particularly to downloading files from a server device using an electronic device.

### BACKGROUND

An electronic device (e.g., a mobile phone or personal digital assistant) can provide functions of network connections. It is convenient to browse a Webpage, view a video, and download files through the network connections. However, a download speed for files is low when a bandwidth of the network is limited.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of an electronic device.

FIG. 2 is a block diagram of an example embodiment of function modules of a file downloading system in an electronic device.

FIG. 3 is a flowchart of an example embodiment of a file downloading method using an electronic device.

FIG. 4 is a diagrammatic view of one embodiment for data flow of downloading a file from a server device using an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY^{TM} flash memory, and hard disk drives.

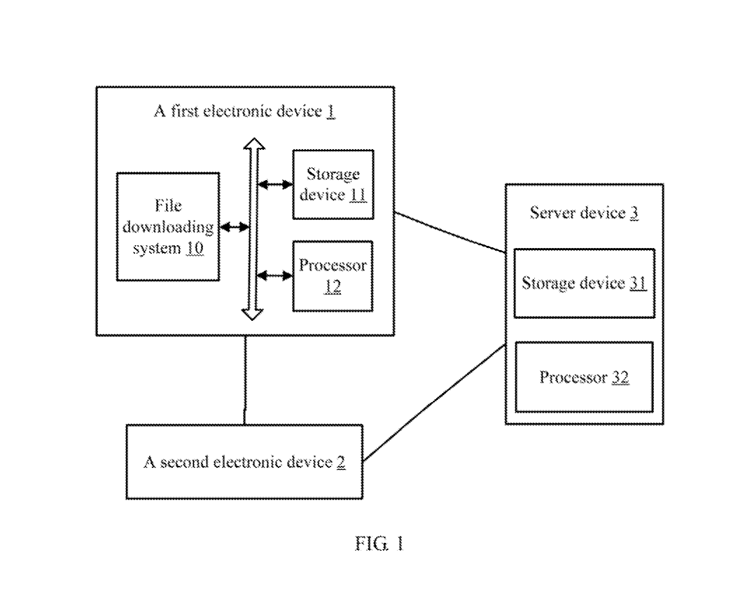

FIG. 1 is a block diagram of an example embodiment of an electronic device. The electronic device is configured for downloading files from a server device 3 and includes a file downloading system 10. The electronic device further includes, but is not limited to, a storage device 11 and at least one processor 12. In at least one embodiment, the electronic device can be a smart phone, a personal digital assistant (PDA), a tablet computer, or other suitable electronic device. A plurality of electronic devices together form a client device. In the example illustrated in FIG. 1, the electronic devices includes a first electronic device 1 and a second electronic device 2.

In at least one embodiment, the second electronic device 2 can be the same as the first electronic device 1, or can be different from the first electronic device 1. For example, both the first electronic device 1 and the second electronic device 2 can be a smart phone, or the first electronic device 1 can be a tablet computer and the second electronic device 2 can be a smart phone. The second electronic device 2 can provide the same functions as the first electronic device 1 when the second electronic device 2 is different from the first electronic device 1. FIG. 1 illustrates only one example of the electronic device, other examples can include more or fewer components than illustrated, or have a different configuration of the various components in other embodiments.

In at least one embodiment, the storage device 11 can include various types of non-transitory computer-readable storage mediums. For example, the storage device 11 can be an internal storage system, such as a flash memory, a random access memory (RAM) for temporary storage of information, and/or a read-only memory (ROM) for permanent storage of information. The storage device 11 can also be an external storage system, such as a hard disk, a storage card, or a data storage medium. The at least one processor 12 can be a central processing unit (CPU), a microprocessor, or other data processor chip that performs functions of the electronic device .

In at least one embodiment, the first electronic device 1, and the second electronic device 2 are connected to a server device 3 through a first network, for example, a mobile network. The first electronic device 1, and the second electronic device 2 are connected to each other through a second network, for example, a wireless local area network (WLAN). The first network and the second network may be based on the same radio access technology or different radio access technologies.

In at least one embodiment, the server device 3 can be a file transfer protocol (FTP) server, a server computer, or other electronic device. The server device 3 can include, but is not limited to, a storage device 31, and at least one processor 32.

The file downloading system 10 can send a file downloading request to a server device 3, and send an assist request to each of the other electronic devices of the client device, thus, enabling each of client devices to receive a segment of the file from the server device 3. A complete file can be generated according to a segment of the file from the server device 3 received by each of the client devices.

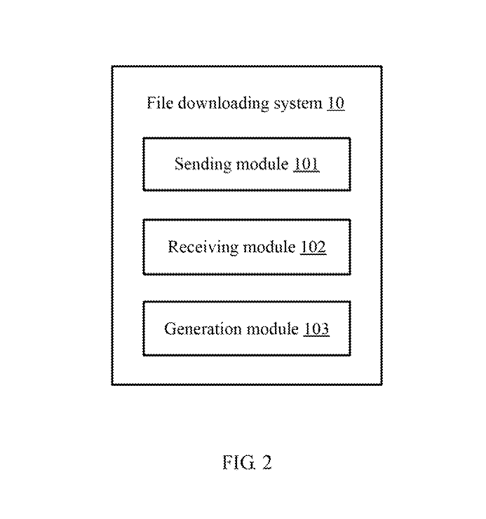

FIG. 2 is a block diagram of one embodiment of function modules of a file downloading system. In at least one embodiment, the file downloading system 10 can include a sending module 101, a receiving module 102, and a generation module 103. The function modules 101, 102, and 103 can include computerized codes in the form of one or more programs which are stored in the storage device 11. The at least one processor 12 executes the computerized codes to provide functions of the function modules 101-103.

The sending module 101 can send a file downloading request to the server device 3, the file downloading request having instructions for downloading a file from the server device 3. In at least one embodiment, the server device 3 can be a file transfer protocol (FTP) server, or a server computer that stores files. In this embodiment, the sending module 101 sends the file downloading request to the server device 3 through the first network.

The sending module 101 can send an assist request to each of the other electronic devices of the client device. The assist request informs each of the other electronic devices to receive a segment of the file from the server device 3. As mentioned above, the first electronic device 1 and the second electronic device 2 are connected to each other through the second network. The sending module 101 in the first electronic device 1 sends the assist request to the second electronic device 2 through the second network to inform the second electronic device 2 to receive the other segment of the file from the server device 3. Furthermore, the sending module 101 can calculate a total number of the electronic devices of the client device, and send the total number to the server device 3 through the first network.

The receiving module 102 can receive a segment of the file from the server device 3, and receive other segments of the file from the other electronic devices of the client device. In at least one embodiment, the server device 3 can divide the file into a predetermined number of segments after receiving the file downloading request from the first electronic device 1, and send one of the predetermined number of segments of the file to each of the electronic devices. The predetermined number of segments of the file is equal to the total number of the electronic devices.

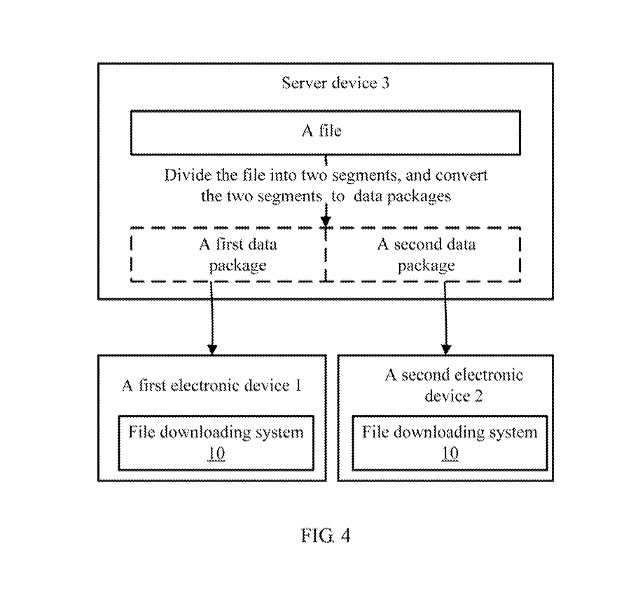

In at least one embodiment, the server device 3 divides the file into a predetermined number of segments, each of the predetermined number of segments have a same size, and include a tag to identify a sequence of the segments. In some embodiments, the server device 3 divides the file into segments by using a WinRAR or a WinZip technology. For example, as shown in FIG. 4, the server device 3 divides the file into two segments, for example, a first segment, and a second segment, each of the two segments having the same size and a tag. The server device 3 compresses each of the two segments, and converts each of the compressed segments of the file to a data package. For example, the server device 3 converts the first segment to a first data package, and converts the second segment to a second data package, then, sends the first data package to the first electronic device 1, and the second data package to the second electronic device 2.

The generation module 103 can generate a complete file by integrating the segment received by the first electronic device 1 and the other segments received by the second electronic device 2, and store the complete file into the storage device 11. In at least one embodiment, the generation module 103 stores the segment and the other segments of the file in a same directory of the storage device 11, and generates the complete file by using the WinRAR or the WinZip technology, based on the tag of the segments.

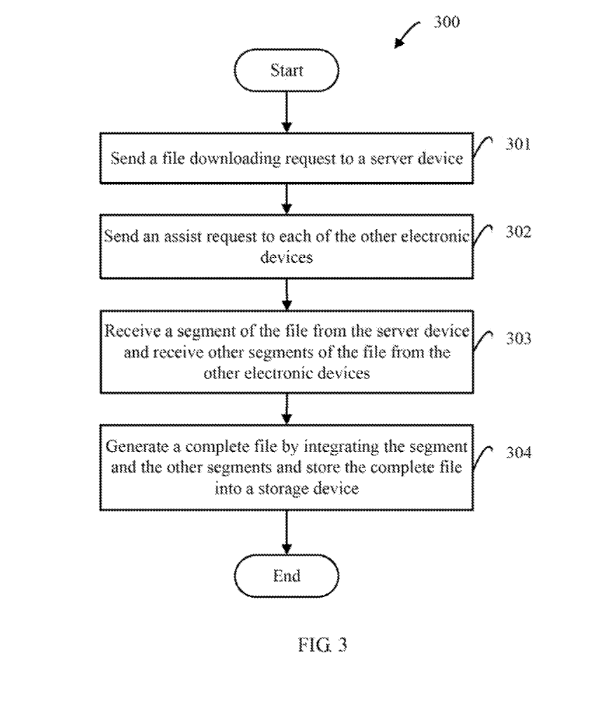

FIG. 3 is a flowchart of an example embodiment of a file downloading method using an electronic device. An example method 300 is provided by way of example, as there are a variety of ways to carry out the method. The example method 300 described below can be carried out using the configurations illustrated in FIG. 1 and FIG. 2, and various elements of these figures are referenced in explaining the example method. Each block shown in FIG. 3 represents one or more processes, methods, or subroutines, carried out in the example method 300. Furthermore, the illustrated order of blocks is illustrative only and the order of the blocks can be changed according to the present disclosure. The example method 300 can begin at block 301. Depending on the embodiment, additional blocks can be utilized and the ordering of the blocks can be changed.

At block 301, a sending module can send a file downloading request to the server device 3, the file downloading request having instructions for downloading a file from the server device 3. In at least one embodiment, the server device 3 can be a file transfer protocol (FTP) server, or a server computer that stores files. In this embodiment, the sending module sends the file downloading request to the server device 3 through the first network.

At block 302, the sending module can send an assist request to each of the other electronic devices of the client device. The assist request informs each of the other electronic devices to receive a segment of the file from the server device 3. As mentioned above, the first electronic device 1 and the second electronic device 2 are connected to each other through the second network. The sending module in the first electronic device 1 sends the assist request to the second electronic device 2 through the second network to inform the second electronic device 2 to receive the other segments of the file from the server device 3. Furthermore, the sending module can calculate a total number of the electronic devices of the client device, and send the total number to the server device 3 through the first network.

At block 303, a receiving module can receive a segment of the file from the server device 3, and receive other segments of the file from the other electronic devices of the client device. In at least one embodiment, the server device 3 can divide the file into a predetermined number of segments after receiving the file downloading request from the first electronic device 1, and send one of the predetermined number of segments of the file to each of the electronic devices. The predetermined number of segments of the file is equal to the total number of the electronic devices.

In at least one embodiment, the server device 3 divides the file into a predetermined number of segments, each of the predetermined number of segments have a same size, and include a tag to identify a sequence of the segments. In some embodiments, the server device 3 divides the file into segments by using a WinRAR or a WinZip technology.

At block 304, a generation module can generate a complete file by integrating the segment received by the first electronic device 1 and the other segments received by the second electronic device 2, and store the complete file into the storage device 11. In at least one embodiment, the generation module stores the segment and the other segments of the file in a same directory of the storage device 11, and generates the complete file by using the WinRAR or the WinZip technology, based on the tag of the segments.

FIG. 4 is a diagrammatic view of one embodiment for data flow of downloading a file from a server device using an electronic device. In at least one embodiment, the client devices include a first electronic device 1 and a second electronic device 2. In at least one embodiment, the sever device 3 receives a file downloading request and a total number of electronic devices from the first electronic device 1. The sever device 3 can divide the file into two segments, and convert the two segments to data packages, for example, a first data package, and a second data package. Then, the sever device 3 can send the first data package to the first electronic device 1, and send the second data package to the second electronic device 2. The first electronic device 1 can receive the second data package of the file from the second electronic device 2. Thus, the first electronic device 1 can generate a complete file by integrating the first data package and the second data package, and store the complete file into the storage device 11.

In another embodiment, the client device may include more than two electronic devices. The sever device 3 may receive a file downloading request and a total number of electronic devices from the first electronic device. The sever device 3 can divide the file into a plurality of segments and convert the segments to data packages. The total number of the data packages is equal to the total number of the electronic devices. Then, the sever device 3 can send the first data package to the first electronic device, send the second data package to the second electronic device, and so on. The first electronic device can receive the other data packages of the file from the other electronic devices. Thus, the first electronic device can generate a complete file by integrating all of the data packages.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A first electronic device, the first electronic device communicating with a plurality of second electronic devices and a server device, the first electronic device comprising:
at least one processor; and
a storage device that stores one or more programs which, when executed by the at least one processor, cause the at least one processor to:
send a file downloading request to the server device, the file downloading request having instructions for downloading a file from the server device;
send an assist request to each of the second electronic devices, wherein the assist request informs each of the second electronic devices to receive a segment of the file from the server device;
receive a segment of the file from the server device,
receive other segments of the file from the second electronic devices; and
generate a complete file by integrating the segment and the other segments, and store the complete file into the storage device.

2. The first electronic device according to claim 1, wherein the at least one processor further:
sends a total number of the first electronic device and the second electronic devices to the server device, wherein the segments of the file are divided according to the total number.

3. The first electronic device according to claim 2, wherein sizes of the segments of the file are the same.

4. The first electronic device according to claim 3, wherein each of the segments of the file comprises a tag to identify a sequence of the segments.

5. A server device, the server device communicating with a client device, the client device comprises a plurality of electronic devices, the server device comprising:
at least one processor; and
a storage device that stores one or more programs which, when executed by the at least one processor, cause the at least one processor to:
receive a file downloading request and a total number of the electronic devices from the client device;
divide the file into a predetermined number of segments; and
send each of the segments of the file to one of the electronic devices.

6. The server device according to claim 5, wherein the predetermined number of segments of the file is equal to the total number of the electronic devices.

7. The server device according to claim 6, wherein sizes of the segments of the file are the same.

8. The server device according to claim 7, wherein each of the segments of the file comprises a tag to identify a sequence of the segments.

9. A computer-implemented method for downloading a file using a first electronic device being executed by at least one processor of the first electronic device, the first electronic device communicating with a plurality of second electronic devices and a server device, the method comprising:
sending a file downloading request to the server device, the file downloading request having instructions for downloading a file from the server device;
sending an assist request to each of the second electronic devices, the assist request informing each of the second electronic devices to receive a segment of the file from the server device;
receiving a segment of the file from the server device,
receiving other segments of the file from the second electronic devices; and
generating a complete file by integrating the segment and the other segments, and storing the complete file into a storage device of the first electronic device.

10. The method according to claim 9, further comprising:
sending a total number of the first electronic device and the second electronic devices to the server device, wherein the segments of the file are divided according to the total number.

11. The method according to claim 10, wherein the segment of the file is generated by:
receiving the file downloading request from the first electronic device;
dividing the file into a predetermined number of segments; and
sending each of the segments of the file to one of the electronic devices.

12. The method according to claim 11, wherein sizes of the segments of the file are the same.

13. The method according to claim 12, wherein each of the segments of the file comprises a tag to identify a sequence of the segments.
